(19) United States
(12) Patent Application Publication
(10) Pub. No.: US 2002/0058172 A1
(43) Pub. Date: May 16, 2002

(54) Method of producing a membrane electrode assembly, and membrane electrode assembly produced using this method, as well as associated fuel cell battery

(76) Inventors: Armin Datz, Poxdorf (DE); Michael Frank, Uttenreuth (DE); Manfred Poppinger, Uttenreuth (DE); Manfred Waidhas, Nurnberg (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/007,392

(22) Filed: Oct. 22, 2001

Related U.S. Application Data
(63) Continuation of application No. PCT/DE00/01244, filed on Apr. 20, 2000.

(30) Foreign Application Priority Data
Apr. 20, 1999 (DE) 199 17 812.7

(51) Int. Cl. H01M 8/10; H01M 4/88; B05D 5/12

(52) U.S. Cl. 429/30; 502/101; 427/115; 429/42

(57) ABSTRACT

A membrane electrode assembly for a self-humidifying fuel cell, a method of its production, and a self-humidifying fuel cell battery include a membrane electrode assembly with a membrane electrolyte, into which at least one catalyst layer is laminated, so that water can be generated in a controlled manner within the membrane by recombination of the reaction gases H₂ and O₂.

### CROSS-REFERENCE TO RELATED APPLICATION

This application is a continuation of copending International Application No. PCT/DE00/01244, filed Apr.20, 2000, which designated the United States.

### BACKGROUND OF THE INVENTION

Field of the Invention

The invention relates to a method of producing a membrane electrode assembly for a self-humidifying fuel cell. The invention also relates to the membrane electrode assembly produced using the method and to an associated self-humidifying fuel cell battery.

For each fuel cell unit, a fuel cell battery has a membrane electrode assembly with a centrally disposed electrolyte, such as, for example, in the case of a polymer electrolyte membrane (PEM) fuel cell, an ion exchange membrane that contains, as its principal constituent, a sulfonated chemical compound. Such a group of chemical compounds bonds water in the membrane to ensure sufficient proton conductivity. At elevated operating temperature and/or at elevated operating pressure, however, the reaction water is not sufficiently bonded and the membrane dries out, in particular, in a region where the reaction gases flow in. On account of the reduced proton conductivity of the membrane at the location, the affect leads to output losses.

Hitherto, the reaction gases have been humidified so that they do not dry out the membrane. However, humidifying the reaction gases creates a problem in that a humidifier additionally must be used.

Therefore, it is desired to use unhumidified reaction gases, to which end two solution approaches have been discovered.

German, Non-Prosecuted Patent Application DE 198 44 983 A1, which is not prior art but filed at a later time, proposes, by disposing a liquid barrier layer between the electrode and the gas distributor or means for distributing gas within the fuel cell unit, to keep the reaction water in the membrane electrode assembly.

Furthermore, M. Watanabe: J. Electrochem. Soc., Vol. 145 No. 4, page 1137 (1998), discloses providing a reaction between the diffusing reaction gases H₂ and O₂ in the membrane. According to the Watanabe process, a platinum salt solution diffuses into the membrane on one side of the membrane, and a reducing agent, such as NaBH₄, diffuses into the membrane from the other side. As such, extremely small platinum particles are formed in the membrane, and, in operation, these particles catalyze the recombination of H₂ and O₂ to form water. A first drawback of the process is the time factor during production because the process is a diffusion-controlled reaction that leads to a distribution profile across the entire thickness of the membrane. In addition, in extreme cases, it is impossible to rule out the possibility of a short circuit being produced by the platinum particles.

The content of the Watanabe publication results substantially from European Patent Application 0 5 89 531 A1, which discloses, in addition, a membrane having a range of different properties being produced by lamination of two partial membranes. Therefore, in such a case, there is no localized catalyst layer.

Membranes with localized catalyst particles and hygroscopic catalyst particles are described, for example, in European Patent Application 0 631 337 A1, corresponding to U.S. Pat. No. 5,766,787 to Watanabe et al.

### SUMMARY OF THE INVENTION

It is accordingly an object of the invention to provide a method of producing a membrane electrode assembly, and membrane electrode assembly produced using this method, as well as associated fuel cell battery that overcomes the hereinafore-mentioned disadvantages of the heretofore-known devices and methods of this general type and that produces a membrane electrode assembly for a self-humidifying fuel cell based on platinum particles that are incorporated in the membrane, which assembly is suitable for mass production and overcomes the drawbacks of the prior art membrane electrode assembly with a humidifier. The invention also provides a self-humidifying membrane electrode assembly that works without the need for diffusion-controlled production of the platinum particles. The invention further provides an associated self-humidifying fuel cell battery.

With the foregoing and other objects in view, there is provided, in accordance with the invention, a method of producing a membrane electrode assembly, including the steps of producing a proton-conductive membrane having a catalyst material by applying a catalyst layer to a side of a first partial membrane in a first step, and, in a second step, applying a second partial membrane to the side of the first partial membrane having the catalyst layer and laminating the second partial membrane to the catalyst layer, and applying electrodes to the proton-conductive membrane.

In the method according to the invention, for the production of a membrane electrode assembly with a catalyst layer, the membrane for the membrane electrode assembly that is to be produced is formed from at least two partial membranes. A catalyst layer, in a first working step, is applied to at least one partial membrane, and then, in a second working step, a further partial membrane is laminated to the first.

In accordance with an added mode of the invention, the first step is performed by coating the side of the first partial membrane with the catalyst layer.

In accordance with another mode of the invention, the catalyst layer is brushed on to the first partial membrane as an ink and/or a dispersion.

In accordance with a further mode of the invention, the catalyst layer is applied by sputtering.

The catalyst layer used may be pure platinum or a platinum-carbon compound or any other catalyst that allows controlled recombination of H₂ and O₂ in the membrane. The catalyst layer is localized in the interior of the membrane, which is of at least two-layer structure, so that a distribution profile of the platinum particles as in the prior art Watanabe membrane is avoided.

The term fuel cell denotes a PEM fuel cell or any other fuel cell whose electrolyte uses liquid water for conductivity.

The term membrane electrode assembly denotes the core piece of a fuel cell, namely, the electrolyte with an electrode on each side.

In accordance with an additional feature of the invention, the electrodes are applied by applying a first electrode to the second partial membrane and a second electrode to the first partial membrane.

In accordance with yet another feature of the invention, hygroscopic particles are added during at least one of the first and second steps.

The quantity and nature (platinum on carbon or pure platinum, etc.) of incorporated catalyst depends on the water consumption of the cell and varies according to the operating system. If a relatively large quantity of water is required, the membrane thickness can be reduced and/or more catalyst with a higher percentage of platinum and/or more hygroscopic particles can be incorporated. The location and/or locations at which the catalyst is incorporated in the membrane can be selected as desired and will, in particular, be wherever the problem of the membrane drying out is greatest.

In such a context, the term “catalyst layer”, in contradistinction to the incorporation of the Watanabe catalyst, denotes a localized layer. The term localized, as it is used herein, is intended to refer to applying the catalyst layer in a defined position on the surface of the first partial membrane and not being diffused. Catalyst layer is intended to mean not only a continuous layer but also a structured layer, i.e., a “holey” layer that is applied, for example, by a printing process. In extreme circumstances, the catalyst layer only includes “catalyst islands” of any desired size and concentration on one or more planes in the membrane.

With the objects of the invention in view, there is also provided a membrane electrode assembly of a fuel cell supplied with reaction gases for processing and having a first partial membrane, a second partial membrane, and electrodes. A catalyst layer of a catalyst material is disposed on a first side of the first partial membrane and has at least one localized catalyst layer. A first side of the second partial membrane is disposed on the catalyst layer to laminate the second partial membrane to the first partial membrane. At least one of the electrodes is disposed on a second side of the first partial membrane and at least another of the electrodes is disposed on a second side of the second partial membrane. The proton-conductive membrane obtains water for humidification purposes from a recombination of the reaction gases within the proton-conductive membrane at the localized catalyst layer.

According to an advantageous configuration, the membrane electrode assembly includes, as well as the catalyst layer, hygroscopic particles made from a material such as, for example, ZrO₂, SiO₂, and/or TiO₂, which are used to store the recombined water.

With the objects of the invention in view, there is also provided a fuel cell battery that is self-humidifying and includes a membrane electrode assembly for a fuel cell supplied with reaction gases for processing and having a first partial membrane, a second partial membrane, and electrodes. A catalyst layer of a catalyst material is disposed on a first side of the first partial membrane and has at least one localized catalyst layer. A first side of the second partial membrane is disposed on the catalyst layer to laminate the second partial membrane to the first partial membrane. At least one of the electrodes is disposed on a second side of the first partial membrane and at least another of the electrodes is disposed on a second side of the second partial membrane. The proton-conductive membrane obtains water for humidification purposes from a recombination of the reaction gases within the proton-conductive membrane at the localized catalyst layer.

Other features that are considered as characteristic for the invention are set forth in the appended claims.

Although the invention is described herein as embodied in a method of producing a membrane electrode assembly, and membrane electrode assembly produced using this method, as well as associated fuel cell battery, it is, nevertheless, not intended to be limited to the details described because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments.

### BRIEF DESCRIPTION OF THE DRAWINGS

FIG. 1 is a fragmentary cross-sectional view of a first partial membrane in the method according to the invention;

FIGS. 2A and 2B are fragmentary cross-sectional views of two embodiments of a structured coating on the first partial membrane of FIG. 1;

FIGS. 3A and 3B are fragmentary cross-sectional views of a second partial membrane on the two embodiments of the structured coating of FIGS. 2A and 2B; and

FIGS. 4A and 4B are fragmentary cross-sectional views of two electrodes on the two embodiments of the membranes of FIGS. 3A and 3B.

### DESCRIPTION OF THE PREFERRED EMBODIMENTS

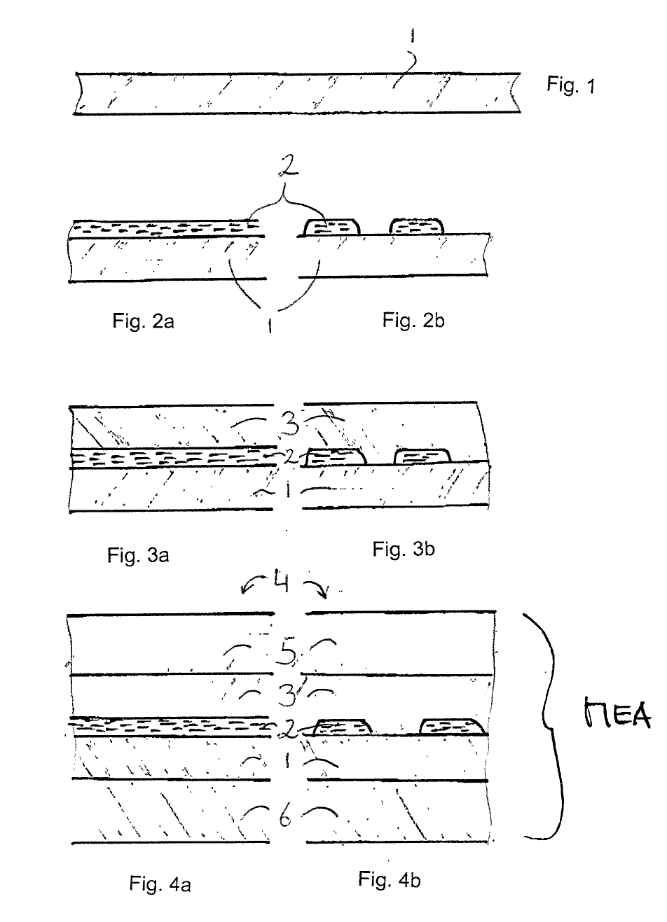

Referring now to the figures of the drawings in detail and first, particularly to FIGS. 1, 2A, and 2B thereof, there are shown initial steps for producing a self-humidifying membrane. FIGS. 1, 2A, and 2B illustrate the catalyst layer 2 applied to the first partial membrane 1 with an ink, paste, or, preferably, with a liquid membrane substance that has deflocculant catalyst particles. The ink and/or dispersion 2 preferably includes one part by mass of platinum on carbon catalyst (40% Pt) and 15 parts by mass of NAFION solution (5% strength solution) that is brushed, sprayed, or printed onto one side of a first partial membrane 1, for example, NAFION membrane 1135 (87 μm). After the ink 2 has dried at 80° C., a second partial membrane 3, for example, NAFION 112 (50 μm) membrane, is pressed onto the coated side of the first partial membrane 1. See FIGS. 3A and 3B. Then, the membrane electrode assembly 4 is produced, for example, by hot-pressing a platinum anode 5, 6 on to one side of the fully laminated membrane and by hot-pressing a platinum cathode 6, 5 onto the other side. See FIGS. 4A and 4B.

The first coated partial membrane 1, 2 can even be laminated to a second or further partial membrane 3 while it is still wet with the liquid ink and/or dispersion 2 and/or with pure platinum powder (e.g., by wet adhesive bonding). The lamination and/or the adhesive bonding may, if appropriate, be assisted by hot-pressing. The membrane is, in such a case, only dried in the fully laminated state.

It is also possible for both partial membranes 1, 3 to be coated with catalyst before they are joined to form the membrane electrode assembly 4.

As a result of a catalyst layer 2 being laminated into the membrane electrolyte, a membrane electrode assembly 4 is produced, which makes the concept of incorporated platinum particles suitable for industrial mass production. The membrane electrode assembly 4 includes a membrane electrolyte into which at least one catalyst layer is laminated so that water can be generated in a controlled manner within the membrane by recombination of the reaction gases H₂ and O₂.

We claim:

1. A method of producing a membrane electrode assembly, which comprises:
producing a proton-conductive membrane having a catalyst material by:
applying a catalyst layer to a side of a first partial membrane in a first step, and
in a second step, applying a second partial membrane to the side of the first partial membrane having the catalyst layer and laminating the second partial membrane to the catalyst layer; and
applying electrodes to the proton-conductive membrane.

2. The method according to claim 1, which further comprises performing the first step by coating the side of the first partial membrane with the catalyst layer.

3. The method according to claim 1, which further comprises performing the applying of electrodes step by applying a first electrode to the second partial membrane and a second electrode to the first partial membrane.

4. The method according to claim 1, which further comprises adding hygroscopic particles during at least one of the first and second steps.

5. A membrane electrode assembly for a fuel cell supplied with reaction gases for processing, comprising:
a proton-conductive membrane having:
a first partial membrane with a first side and a second side;
a second partial membrane with a first side and a second side;
a catalyst layer of a catalyst material disposed on said first side of said first partial membrane and having at least one localized catalyst layer;
said first side of said second partial membrane disposed on said catalyst layer to laminate said second partial membrane to said first partial membrane; and
electrodes, at least one of said electrodes disposed on said second side of said first partial membrane and at least another of said electrodes disposed on said second side of said second partial membrane; and
said proton-conductive membrane obtaining water for humidification purposes from a recombination of the reaction gases within said proton-conductive membrane at said at least one localized catalyst layer.

6. A fuel cell battery, comprising:
at least one self-humidifying membrane electrode assembly for a fuel cell supplied with reaction gases for processing, said membrane electrode assembly having:
a proton-conductive membrane having:
a first partial membrane with a first side and a second side;
a second partial membrane with a first side and a second side;
a catalyst layer of a catalyst material disposed on said first side of said first partial membrane and having at least one localized catalyst layer;
said first side of said second partial membrane disposed on said catalyst layer to laminate said second partial membrane to said first partial membrane; and
electrodes, at least one of said electrodes disposed on said second side of said first partial membrane and at least another of said electrodes disposed on said second side of said second partial membrane; and
said proton-conductive membrane obtaining water for humidification purposes from a recombination of the reaction gases within said proton-conductive membrane at said at least one localized catalyst layer.
